(19) United States
(12) Patent Application Publication
(10) Pub. No.: US 2006/0255309 A1
(43) Pub. Date: Nov. 16, 2006

(54) Valve bonnet assembly

(76) Inventors: Joseph Peter Marcilese, Chatsworth, CA (US); Dean C. Richards, Chatsworth, CA (US); Michael C. Gagne, Chatsworth, CA (US)

Correspondence Address: Maria Erlinda C. Sarno, Esq., P.O. Box 1023, Artesia, CA, 90702, US

(21) Appl. No.: 11/113,474

(22) Filed: Apr. 25, 2005

(51) Int. Cl. F16K 25/00

(52) U.S. Cl. 251/368

(57) ABSTRACT

An improved bonnet assembly for a valve, comprising a hollow bonnet housing an actuator assembly comprising an actuator connected to a spindle, the hollow bonnet having a plurality of orifices to allow free entry and exit of a liquid such as a cleaning solution within the bonnet and to enable the liquid to thoroughly contact and exit the bonnet assembly without the need of disassembly. A handle is connected to the spindle of the actuator assembly within the bonnet to cause the upwards and downwards motion of the actuator assembly. The bonnet assembly connects to the rest of the components of the valve by connectors known in the art such as fasteners, clamps and retaining nuts or ring. The valve or parts of the valve such as the bonnet assembly or its components are made of performance engineered polymeric material to prevent corrosion and/or galling, and also reduce the weight and sometimes the cost of the valve without sacrificing quality and performance.

This invention relates to a sanitary bonnet assembly for a valve suitable for use in the pharmaceutical, chemical, biotechnology, nanotechnology, food, beverage, semiconductor and similar industries.

### BACKGROUND

A bonnet is one of the major components of certain types of valves. A valve is a device for controlling the flow or pressure of fluids such as liquids, gases, and slurries in a pipe or other enclosures. Control of flow is by means of a movable element that opens, shuts, or partially obstructs an opening in a passageway. There are a variety of valves in use, their classification is based on function, flow medium, mechanical design, method of operation, and motion of the parts within the valve relative to the valve seat and the manner in which the motion of the parts within the valve is produced. Weir and radial style valves are commonly used when sanitary and sterile conditions are desired because the mechanism and the flow path are simple in construction and the working mechanical parts of the valve are isolated from the fluid flowing through the valve. Aside from the bonnet, the other main parts of a weir or radial style valve are a valve body, a diaphragm placed between the bonnet and valve body, and an actuator connected to a stem or spindle which is in communication with a handle for controlling the amount of pressure applied to the diaphragm which is usually made of a flexible material. In the weir and radial valves, the diaphragm is the movable element that opens, shuts, or partially obstructs an opening in a passageway which is driven or controlled by the actuator which pushes the diaphragm against a weir on a weir valve or against an opening of the passageway on a radial valve to partially close, close or stop the fluid flow. The actuator is also referred to in the field as the compressor. The diaphragm is usually the part that gets in direct contact with the fluids. Fluid is allowed to flow when the diaphragm is not pressing on the weir or closing the fluid path. Herein, the actuator, spindle or stem, and the bonnet are collectively referred to as the bonnet assembly and the actuator connected to a spindle is referred to as actuator assembly which is also sometimes referred to as compressor device. The actuator assembly is situated within the bonnet which is a hollow housing. The components or parts of the components of the actuator responsible for the operation of the valve are mostly housed inside the bonnet. Although it is only the diaphragm that gets direct contact with the fluid, it is sometimes preferred to clean the entire valve. There are no set cleaning schedules. This can be done after every usage or periodically at a given interval, mostly dictated by good manufacturing practices and the like . Most manufacturers, especially those that produce sanitary or sterile products, have their own validated cleaning procedure. These valves are presently cleaned by dismantling the individual components of each part of the valve, the bonnet assembly further disassembled into its components, and subjecting these to a cleaning procedure. Some submerge the entire valve or the bonnet assembly into the cleaning solution without dismantling but this practice ruins the bonnet assembly and consequently, the valve, because some or all parts of the present valves or bonnet assemblies are made of materials that are usually adversely affected by the cleaning solution. Additionally, the cleaning process requires quite a bit of cleaning and rinsing solutions before the device is thoroughly cleaned because the present valves or bonnet assemblies are not properly designed to allow the cleaning solution to freely flow into, around the parts of the valve or bonnet assembly, and out of the device. Herein, cleaning solutions include other liquids such as the rinsing solutions even if it is not specifically stated. Looking at the main parts of a valve, cleaning the bonnet assembly would be the most tedious and time consuming. It is therefore desirable to design a bonnet assembly that can be cleaned without disassembly into its components or into parts of each components.

The parts of the present valve that are not made of stainless steel, for example, the actuator and more specifically the spindle, is usually made of brass or bronze. With repeated usage, corrosion occurs on the spindle, particularly those that are threaded, due to the frictional rubbing between the spindle and the part of the actuator in direct communication or connected to the spindle, coupled with the chemical/s in the cleaning solution reacting with the brass and/or bronze material. Galling can also occur on assemblies that are manufactured entirely with stainless steel. Galling and corrosion combine to cause seizure especially on any threading mechanism employed in the valve thereby making the valve non-functional . Some valve manufacturers have substituted the brass and bronze material with stainless steel to prevent corrosion. This delays the process but does not solve the problem. The use of stainless steel for the spindle, with or without threading, requires a lubricant. This lubricant may not be compatible with the fluid being processed and in such situation may in itself be a contaminant. Further, the lubricant wears out with time. Also, the cleaning solution may react with the lubricant to cause its breakdown or crystallization which hastens the galling process.

It is therefore an object of this invention to provide a valve having a bonnet assembly that can be cleaned without dismantling the assembly into its parts.

It is also an object of this invention to provide a method on how the bonnet can be redesigned on the various types of valves to allow cleaning without disassembly.

It is a further object of this invention to provide a spindle or stem and/or bonnet assembly or a valve as a whole made of a material that is not susceptible to galling and/or corrosion.

### SUMMARY OF THE INVENTION

The invention relates to an improved bonnet assembly for a valve, comprising a hollow bonnet housing an actuator assembly comprising an actuator connected to a spindle, the hollow bonnet having a plurality of orifices to allow free entry and exit of a liquid such as a cleaning solution within the bonnet and to enable the liquid to thoroughly contact and exit the bonnet assembly without the need of disassembly. A handle is connected to the spindle of the actuator assembly to cause the actuator assembly to move upwards and downwards. For spindles having threads engaging a matching surface on the actuator, the handle cause the threads of the spindle to engage upwards and downwards along the matching surface of the actuator as the handle moves the actuator assembly up and down. The bonnet assembly connects to the rest of the components of the valve by connectors known in the art such as fasteners, clamps and retaining nuts or ring. The orifices may be of different geometric shapes and designs. These orifices may be formed by casting or they may be bored at a lateral surface of the hollow bonnet. Because a valve is exposed to different liquids not just the cleaning solutions and the different types of fluids being processed using a valve, it is recommended to manufacture the valve as a whole or the components of the valve such as the bonnet assembly as a whole, or only the actuator assembly within the bonnet assembly, or only the spindle within the actuator assembly of the bonnet assembly or only the threaded components within the valve, with a corrosion and galling resistant material. A suitable corrosion and galling resistant material is a performance engineered polymeric material. These materials are especially ideal for parts within the valve or the bonnet assembly that are subjected to constant rubbing of the part against another part of the valve such as the spindle. Typical examples of this performance engineered polymeric material include acrylonitrile butadiene styrene (ABS), fluoropolymers, polyamides (Pas-Nylon), polyarylates (PAryls), polycarbonate (PC), thermoplastic polyesters (PET, PBT), thermoplastic polyimides (PI, PAI, PEI), polyoxymethylene (POM Acetal), polyphenylene oxide (PPO), polyaryletherketones (PEEK, PEK), polysulphones (Psul, PES), polyphenylene sulphide (PPS), liquid crystal polymers (LCPs), fluorinated ethylene propylene (FEP), perfluoroalkoxy (PFA), and polyvinylidene fluoride (PVDF) and some amorphous and semi-crystalline thermoplastics. The substitution of the performance engineered plastic or polymeric material for the metals also lightens the weight of the valve and may also cut the cost of the valve without sacrificing quality and performance. The bonnet assembly herein is particularly adoptable to a weir type valve or a radial style valve.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWING

Aspects of the present invention are illustrated by way of example, and not by way of limitation, in the accompanying drawings, wherein:

FIG. 1 is a conventional weir type valve having a cut out portion showing the interior of the valve.

FIG. 2 is a conventional radial style valve having a cut out portion showing the interior of the valve.

FIG. 3 is an exploded view of the major parts of a prior art weir type valve.

FIG. 3A is an exploded view of the major parts of the claimed weir type valve.

FIG. 3B is an exploded view of the major parts of the prior art radial style valve.

FIG. 3C is an exploded view of the major parts of the claimed radial style valve.

FIG. 4 is an isometric view of a prior art bonnet.

FIG. 5 is an isometric view of a proposed bonnet for a weir type valve.

FIG. 6 is an isometric view of a proposed bonnet for a radial style valve.

FIG. 7 is an isometric view of a prior art bonnet with a weep-hole.

FIGS. 8A-K show examples of different geometrical designs of the orifice in a weir type valve bonnet illustrated in a plan and isometric view.

FIGS. 9A-F show examples of different geometrical designs of the orifice in a radial style valve bonnet illustrated in a plan and isometric view.

FIG. 10 is a plan and isometric view of an orifice formed by casting the smaller diameter end with the flanged base of the bonnet of a weir type bonnet.

FIG. 11 is a plan and isometric view of an orifice formed by casting the smaller diameter end with the flanged base of the bonnet of a radial style bonnet.

FIG. 12A is a cross sectional view of a prior art weir valve bonnet assembly without a cleaning solution.

FIG. 12B is a cross sectional view of a prior art weir valve bonnet assembly with a cleaning solution shown in solid black

FIG. 13A is a cross sectional view of a prior art radial style valve bonnet assembly without a cleaning solution.

FIG. 13B is a cross sectional view of a prior art radial style valve bonnet assembly with a cleaning solution shown in solid black

FIG. 14A is a cross sectional view of the improved weir valve bonnet assembly without a cleaning solution.

FIG. 14B is a cross sectional view of the improved weir valve bonnet assembly with a cleaning solution shown in solid black.

FIG. 15A is a cross sectional view of the improved radial style valve bonnet assembly without a cleaning solution.

FIG. 15B is a cross sectional view of the improved radial style valve bonnet assembly with a cleaning solution shown in solid black.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any means of providing a plurality of orifices or openings in the body of a bonnet to facilitate the flow of liquids within the bonnet housing and the substitution of the metal material on the valve or any or all of the following: metal spindle or other threaded parts of the valve, the actuator or compressor, or the bonnet with a suitable high temperature resistant engineered plastic or polymeric material, also referred to as performance engineered plastic or polymeric material, to prevent galling and corrosion is within the scope of this invention. The detailed description includes specific details to provide a thorough understanding of the claimed invention and it is apparent to those skilled in the art that the claimed invention may be practiced without these specific details.

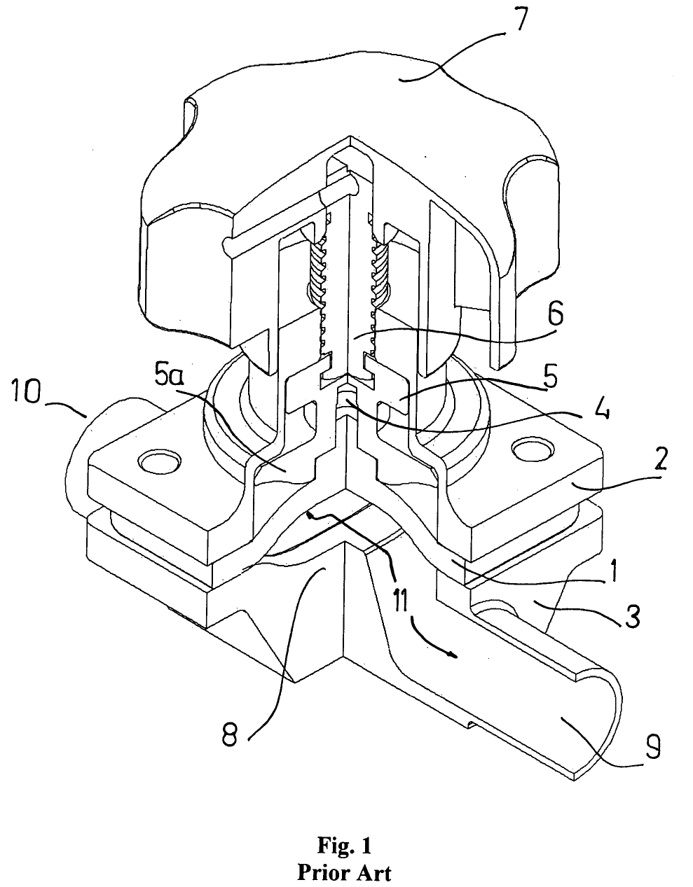

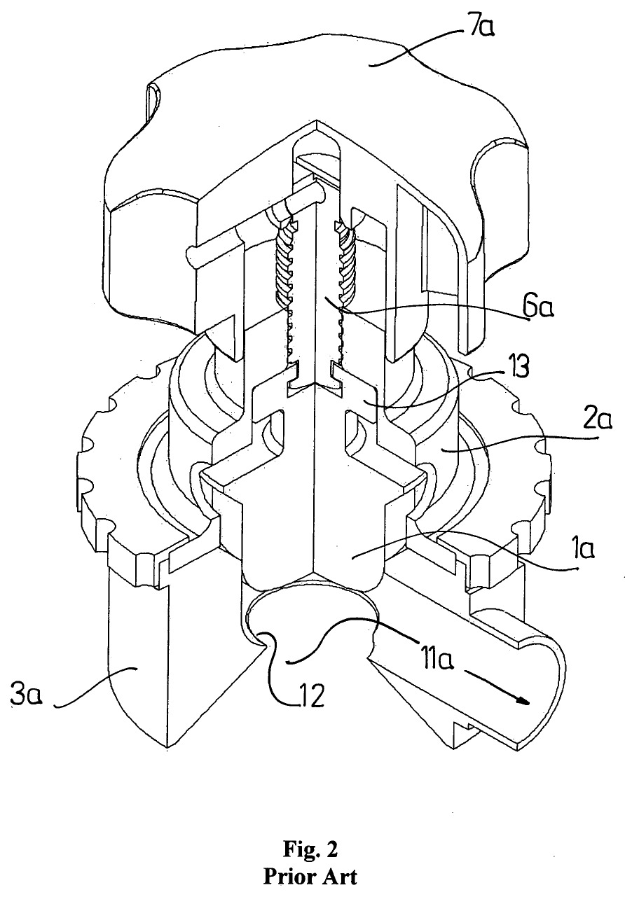

The improved cleanable bonnet assembly 100 of this invention can be adopted to a variety of process valves, especially the weir type valves and radial style valves shown in FIGS. 1 and 2. The weir type valve differs from a radial style valve mainly on the design of the fluid path or passageway. A brief description of the valves are given to assist in understanding the invention. The illustrations herein shows the major parts of the valves. Other valves may have more components aside from the ones shown herein.

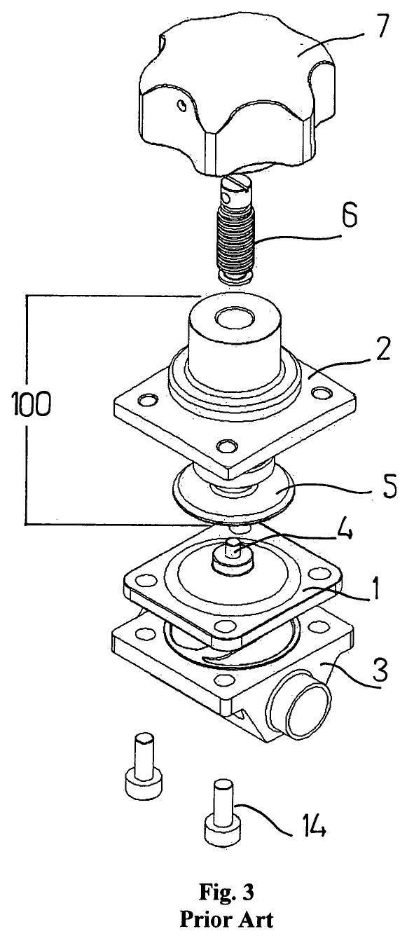

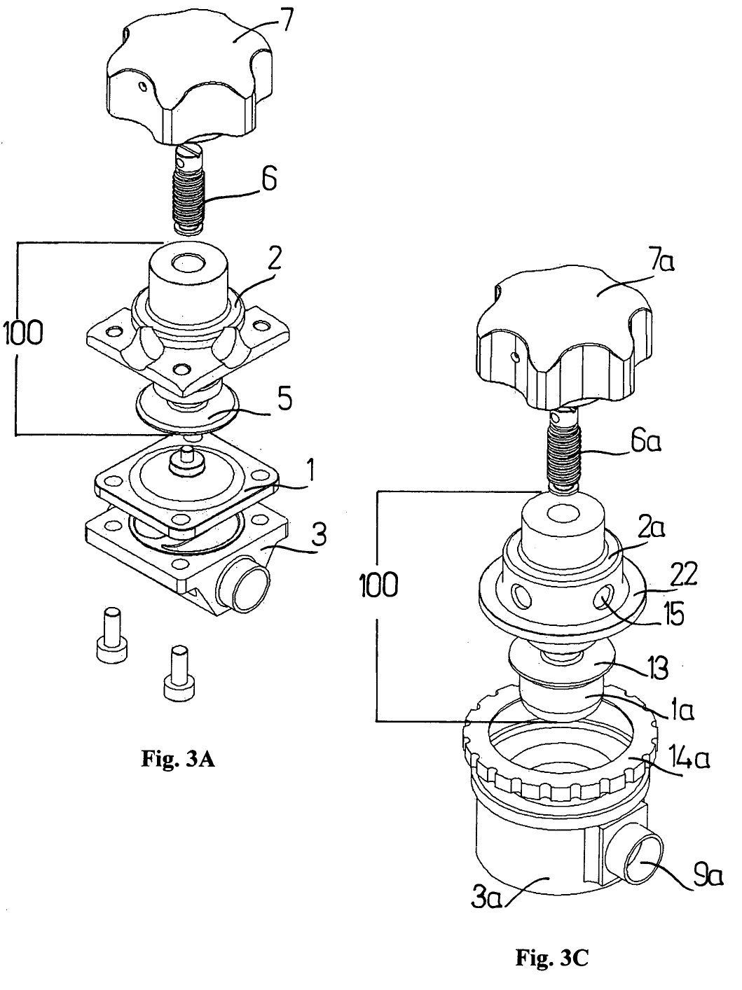

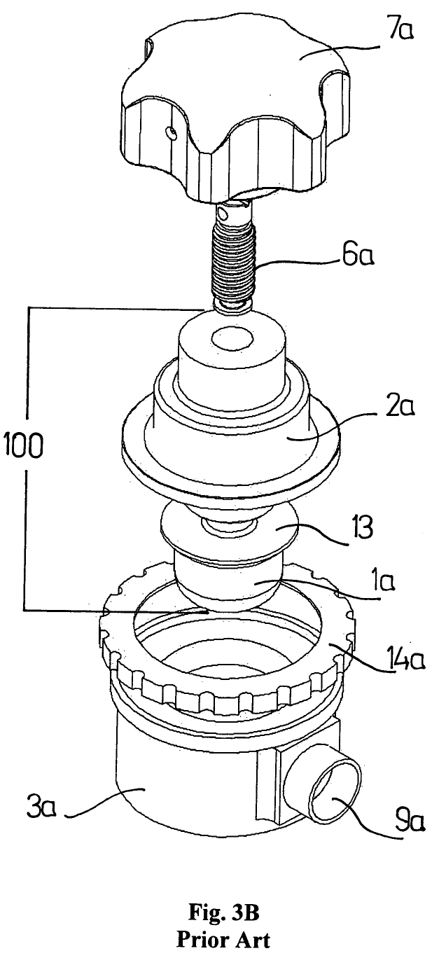

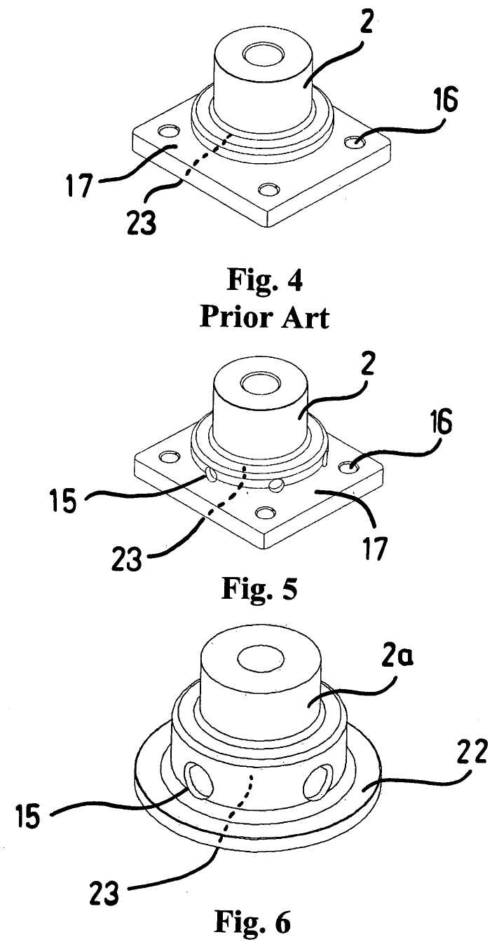

A typical weir type diaphragm valve as shown in FIG. 1, comprises a diaphragm 1 situated between a bonnet 2 and a valve body 3. The diaphragm 1 is connected to one side of the bonnet 2 by a connector 4 which is in turn connected to an actuator 5 generally comprising a compressor 5a with one end connected to the diaphragm 1 through the connector 4 and the other end connected to a stem or spindle 6 whose up and down motion caused by the turning of a handle 7 connected to the spindle 6 controls the position of the diaphragm 1 in relation to the weir 8 of the diaphragm valve. The weir 8 is disposed intermediate and transversely of an inlet 9 and an outlet 10 port of a passageway 11 of the valve body 3 wherein the fluid flows. The passageway 11 is sometimes, as illustrated here, a chamber created when the bonnet, diaphragm and valve body are fastened together. The connector 4 is the molded head of and integral to the diaphragm 1 fitting a slot or other connecting means in the compressor 5a. The connector 4 can also be a screw that is molded into the diaphragm and threads into the compressor 5a. FIG. 3 shows how the parts are assembled together using a fastener 14. Different types of fasteners can be used and are known in the art.

A radial style diaphragm valve is shown in FIG. 2. A radial style valve generally comprises a diaphragm 1a, a valve body 3a having a valve seat 12 and a fluid passageway 11a from an inlet 9a to an outlet 10a (not numbered but shown), and a bonnet 2a comparable with the bonnet 2 of the weir type valve shown in FIG. 1. The bonnet 2a includes an actuator 13 connected to a diaphragm 1a having a spindle 6a connected to a handle or knob 7a. The bonnet, in this type of valve, connects directly to the valve body as shown in FIG. 3B by a retaining nut 14a or a clamping device with the actuator 13 connected to the diaphragm 1a situating inside the bonnet. The turning of the handle or knob 7a, as in the weir type valve controls the position of the diaphragm 1a in relation to the valve seat 12 of the fluid passageway 11a. Fluid flow is stopped when the diaphragm fully presses on the valve seat which closes the passageway. The bonnet 2a including the actuator 13 with the spindle 6a is herein also collectively referred to as bonnet assembly 100.

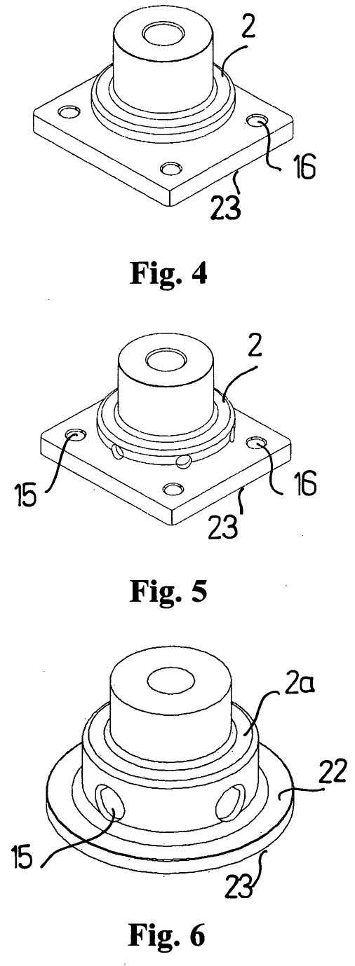

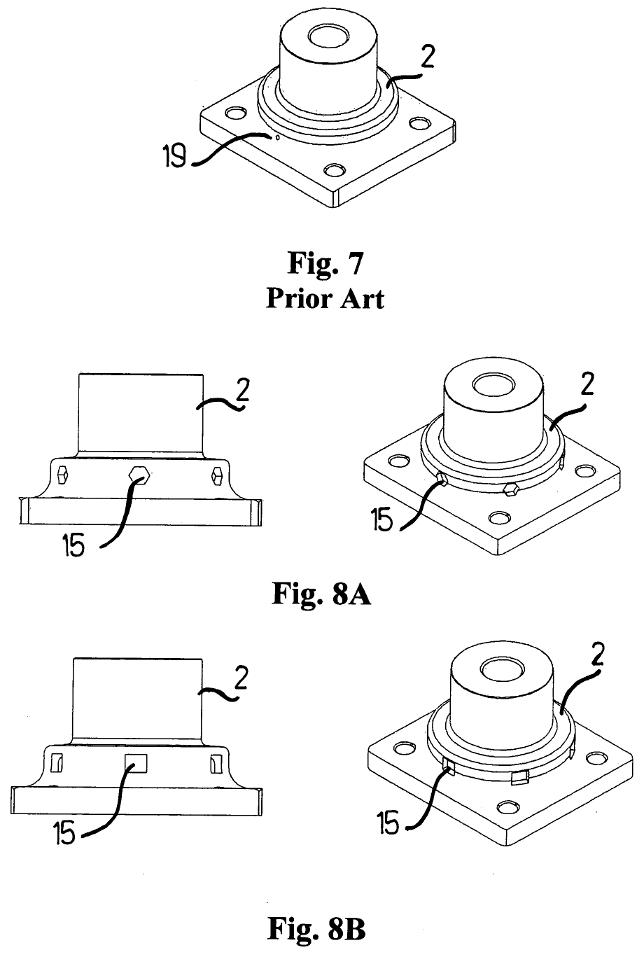

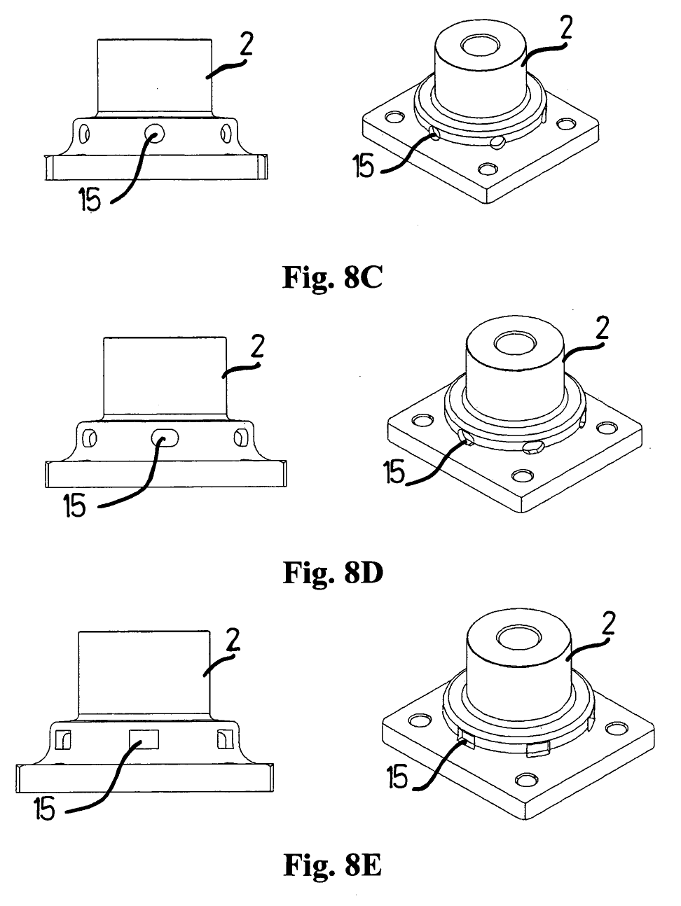

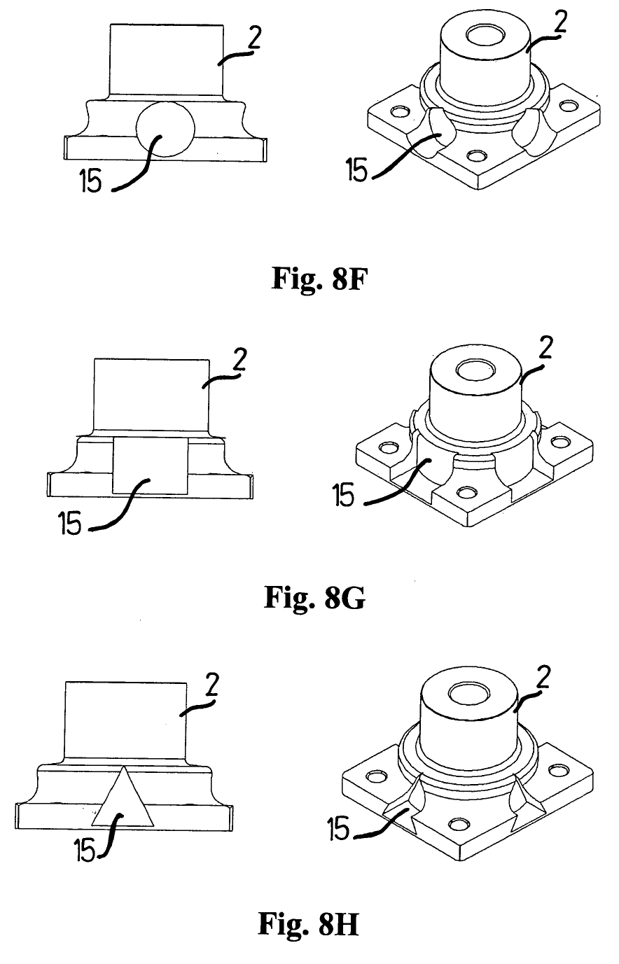

The invention is centered at the bonnet assembly 100. Therefore, a detailed description of the valve body and the diaphragm is not necessary. FIG. 3 and 3B are exploded views of a prior art weir type valve and a prior art radial style valve, respectively. FIG. 3A and 3C are exploded views of the claimed weir type and radial style valve showing the general parts of the valve and how they relate to each other, most specifically the bonnet 2. FIG. 4 is an isometric view of a prior art bonnet while FIG. 5 is an isometric view of a proposed bonnet for a weir type valve and FIG. 6 is an isometric view of a proposed bonnet for a radial style valve. One difference between the prior art and the claimed bonnets 2 and 2a are the presence of orifices 15 in the bonnet as shown in FIGS. 5 and 6 versus FIG. 4 for the free entry and exit of liquids especially the cleaning and rinsing solutions into and out of the bonnet assembly. The orifices will allow cleaning of the bonnet assembly without the need of disassembling it into its components. Herein, the number designation of the parts are maintained with small letter suffixes added to the radial style valve for parts comparable to the weir type valve. The openings 16 at the base 17 of the bonnet for the prior art and claimed bonnet of a weir type valve as shown in FIG. 4 and FIG. 5 are openings to accommodate the fasteners 14 connecting the bonnet to the diaphragm and the valve body. These should not be confused with the orifices 15 that are used as passageway for the cleaning solution 18. Some commercial bonnets have a port in the bonnet referred to in the industry as weep-hole 19 as shown in FIG. 7. The weep-hole is used only for detecting diaphragm failure. When a diaphragm fails, the fluid leaks out of the diaphragm which is detected by the presence of liquid or moisture at the weep hole. The weep hole is usually limited to one and are usually a small drilled hole or a threaded port that could accommodate a cap for closure. It is designed to have the smallest feasible diameter to maximize surface tension because of the concern for contamination and dust entering the weep hole and also to prevent any external fluid from entering the valve or the bonnet assembly through the weep hole. This concern stems from the present difficulty of cleaning the valve especially the bonnet assembly every after usage. The drilled weep hole is usually no more that ⅛ of an inch in diameter and for the threaded port, they are usually ⅛ inch NPT (national pipe thread). The size of these holes is not sufficient to allow free entry and draining of the cleaning solution 18. Further, because the weep-hole in existing bonnets is meant to be like a vent, aside from its size, it may not be positioned correctly, that is, not in the right location along the bonnet body or is not sufficient in quantity to allow free entry and exit of a clearing solution/s.

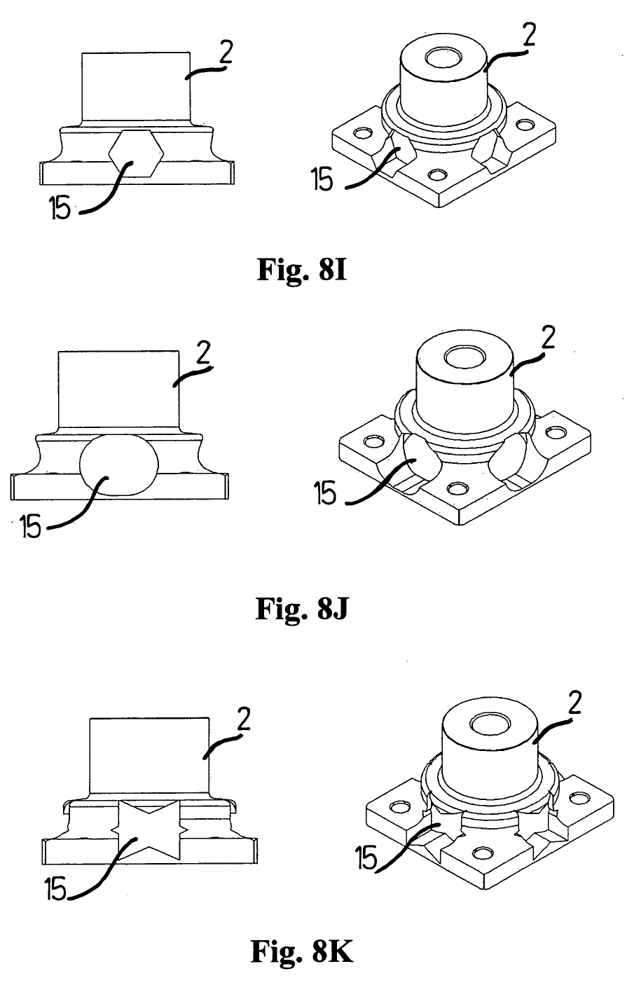

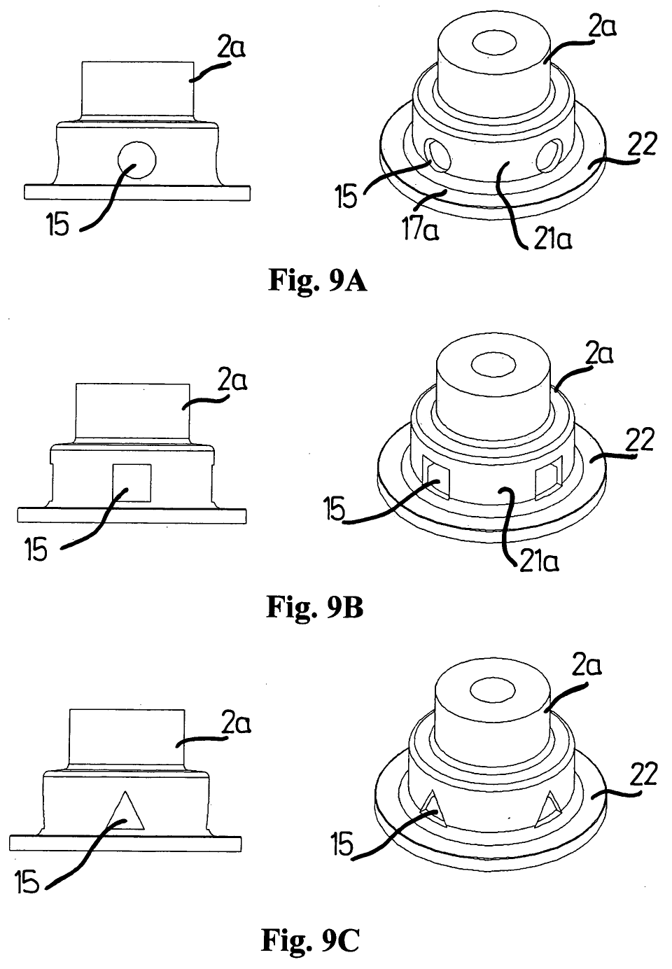

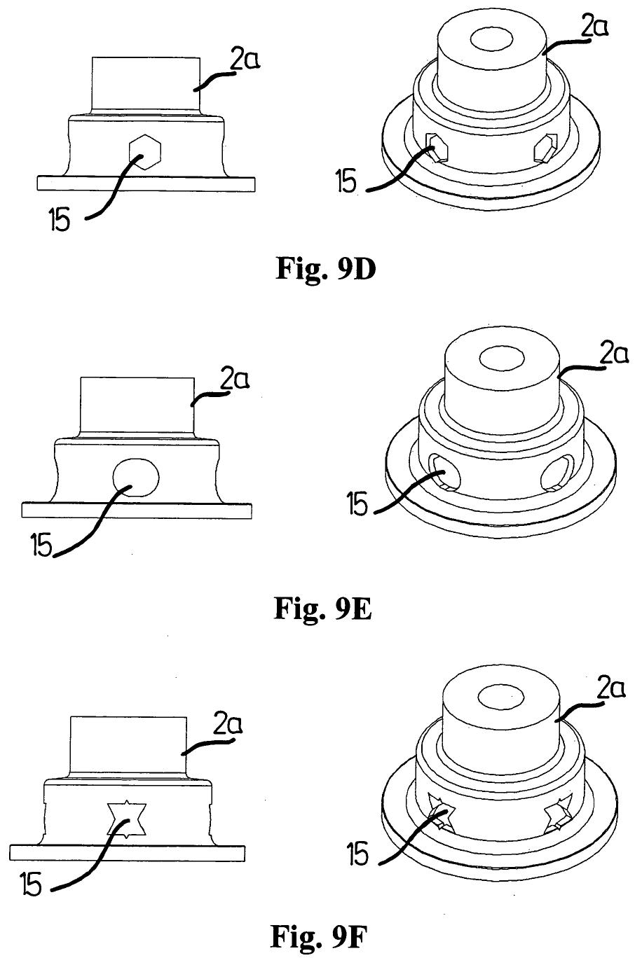

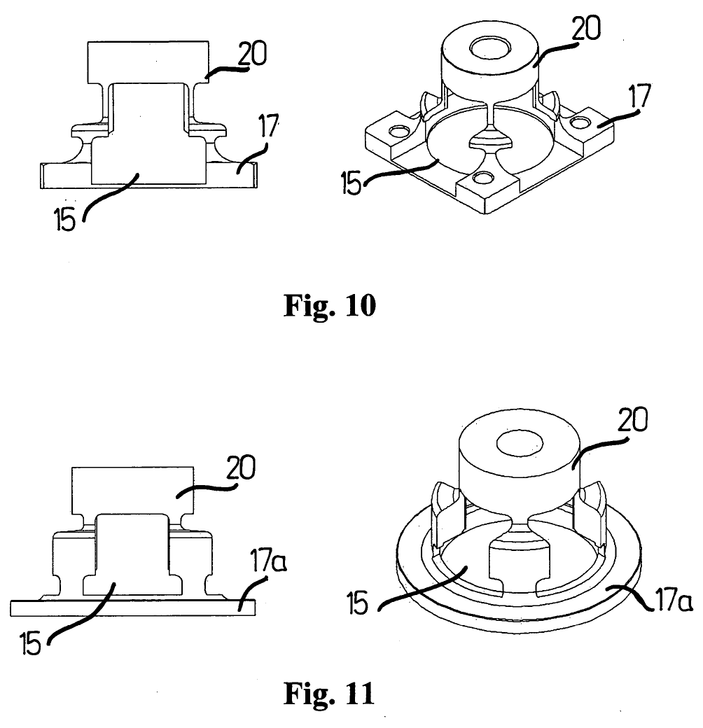

In contrast, the orifices of the claimed invention are more than one and are of a diameter usually greater than the weep-hole to allow free flow of any liquid such as the cleaning and rinsing solutions through the bonnet assembly. The number of orifices that can be drilled or bored into the bonnet is largely dependent upon the surface area of the bonnet and the structural strength required for the bonnet to adequately house the actuator assembly. These orifices 15 can have different geometric designs. Some examples of the different geometric designs illustrated in a plan and isometric views for the orifices on a weir type valve are shown in FIGS. 8A-8K. FIGS. 9A-9F show the different geometrical designs of the orifices on a radial style valve. It is obvious that there are other geometrical designs that are not shown here. It is also possible to have an orifice 15 formed by casting the smaller diameter end 20 with the flanged base 17 of the weir type bonnet as shown in FIG. 10 in a plan and isometric view or with the flanged base 17a of the radial style bonnet as shown in FIG. 11 in a plan and isometric view. These cast type orifices will allow the best ingress and egress of the cleaning and rinsing solutions through the bonnet assembly. As shown in FIGS. 8A-8E, the orifices may be bored and confined at the lateral surface of the bonnet proximal to the base 17 having the larger diameter 21 housing the actuator 5 or it can originate at this location and extend to the base 17 of the bonnet as shown in FIGS. 8F-8K. In the latter, the orifice is etched out by taking a portion of the bonnet base 17. This results in a wider orifice or opening for better fluid flow. In the radial style valve, the orifices are confined at the lateral surface of the larger diameter section 21a because the flange 22 of base 17a is needed to connect the bonnet 2a with the valve body 3a using the retaining nut or clamp 14a. It is recommended to smoothen, if possible, the peripheral edges of the orifices to avoid or reduce any liquid hold up due to surface tension. The orifices 15 are located at these positions because they allow drainage of the cleaning solution regardless of which side the valve may be resting on. Also, the presence of the orifices allow immediate detection of diaphragm failure.

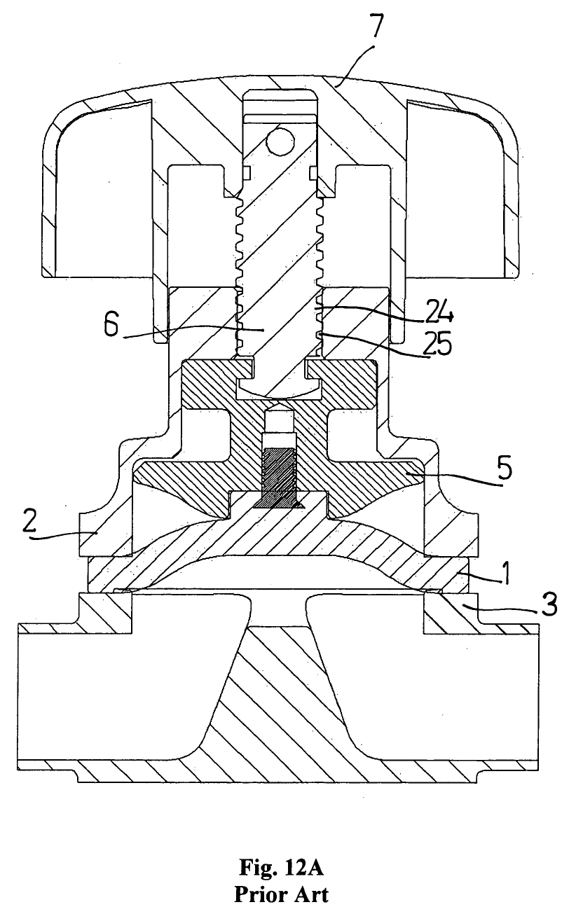

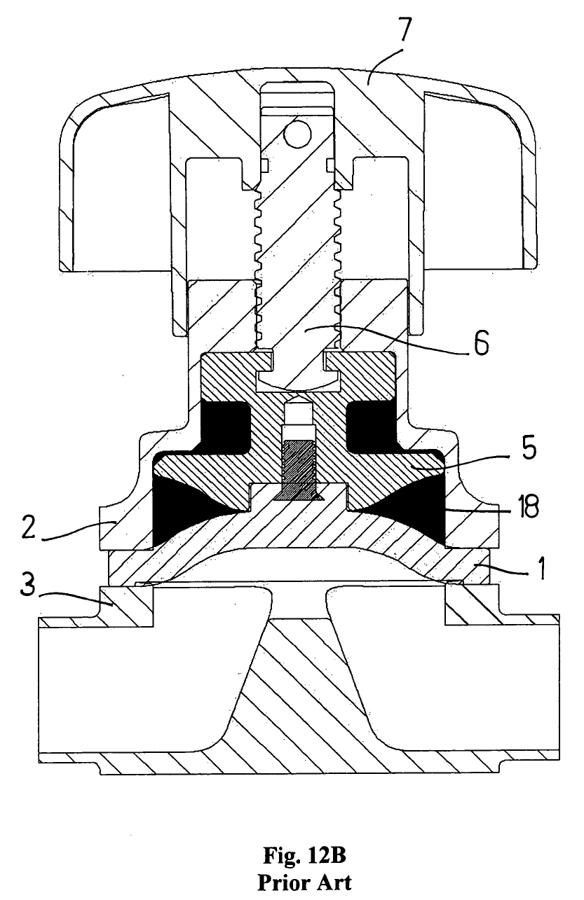

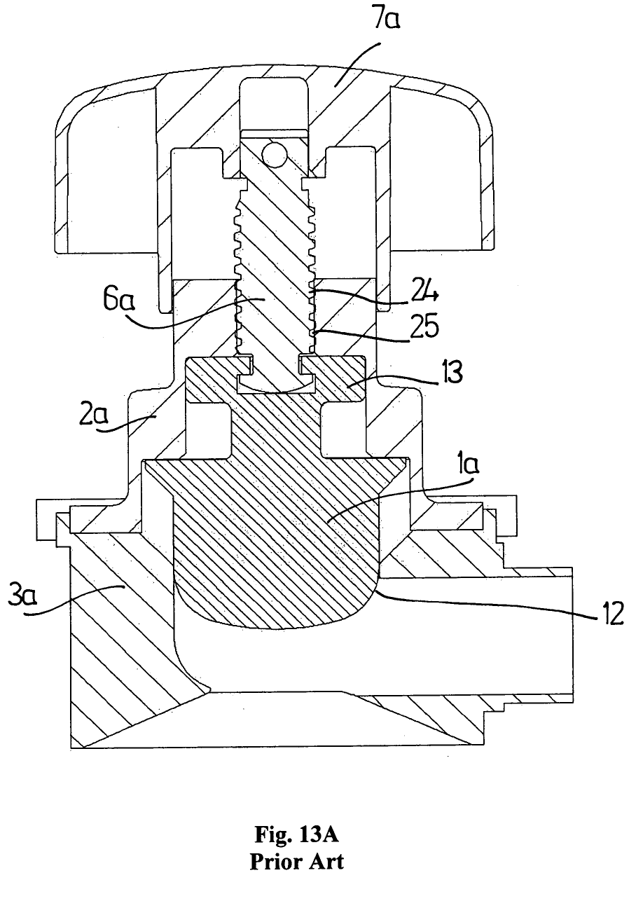

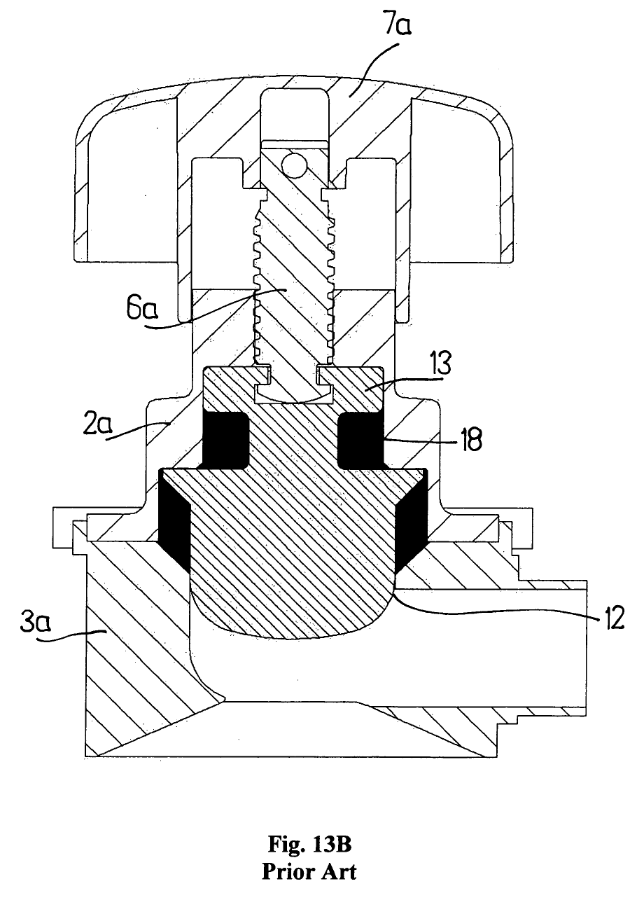

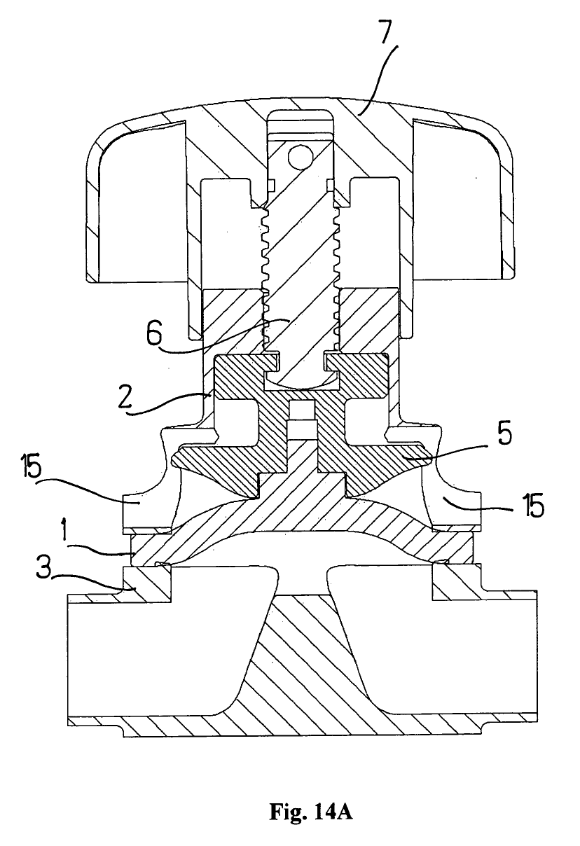

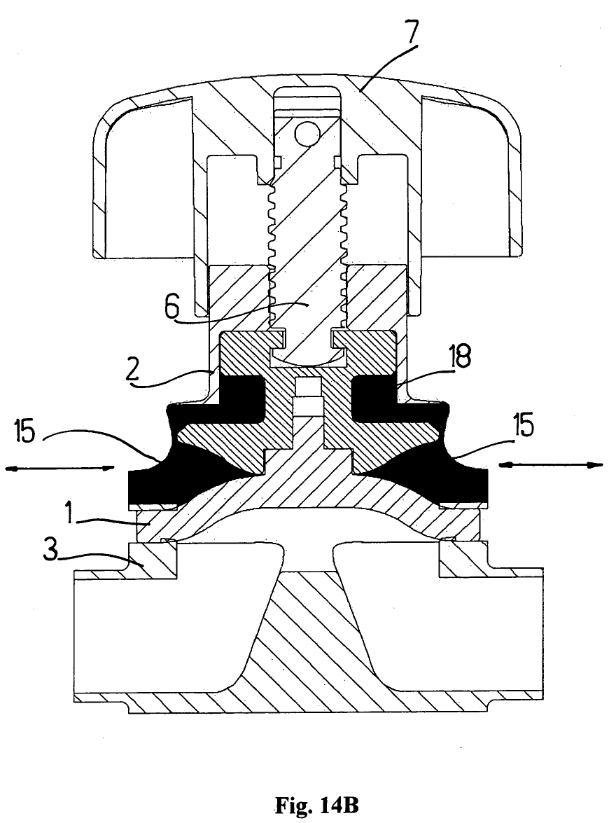

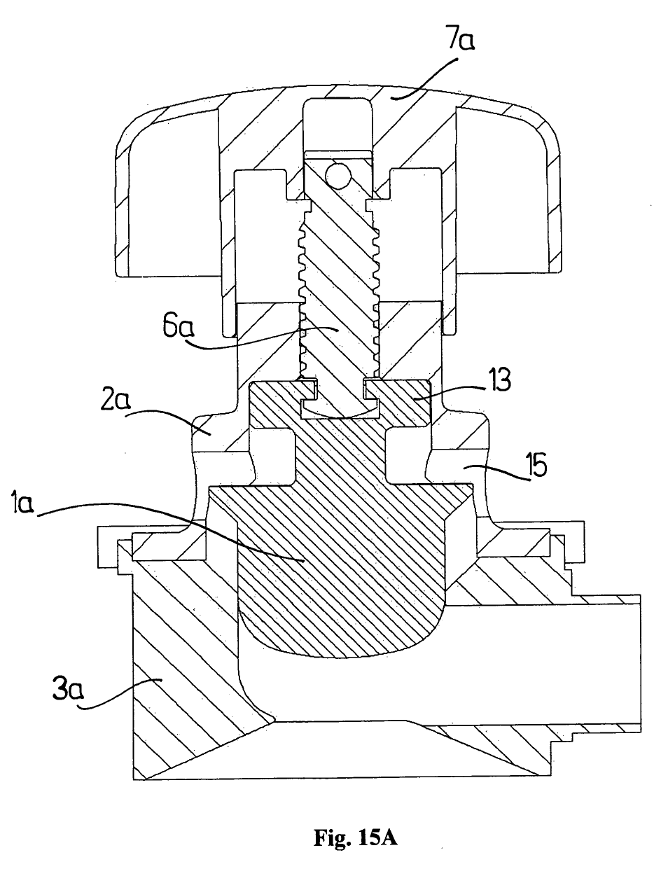

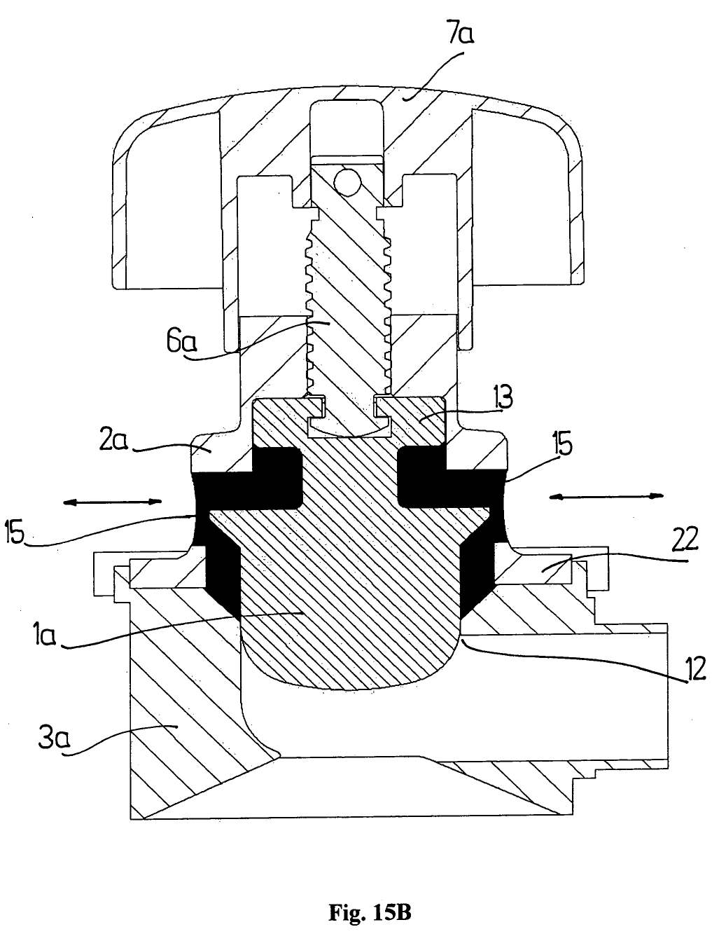

With the existing valves, the cleaning solution or any other liquid enters the interior of the bonnet but has no way for easy exit or for rapidly enveloping the entire bonnet assembly 100 as shown in FIGS. 12A, 12B, 13A and 13B. Here, the cleaning solution 18 enter the assembled bonnet assembly 100 mainly through the bottom face 23 (see FIGS. 4, 5, and 6 for location indicator) of the bonnet when this is not attached to the diaphragm or the valve and has to exit at the same location 23. Therefore, when the assembled bonnet assembly 100 is submerged to the cleaning solution, the solution will tend to stay inside the bonnet especially those that have managed to rise above the actuator resulting in inferior cleaning of the parts because the cleaning solution, dirt and contaminants will not be thoroughly swept out of the interior of the bonnet. Also, having no port/s for free entry and exit of the cleaning solution, it would be difficult to thoroughly wash an assembled bonnet assembly with an automatic washer. Cleaning of the bonnet assembly aside from disassembly into its components as stated above can be done by the different washing methods such as submersion into the cleaning solution for manual cleaning, by an automated COP (clean out of place) parts washer, or by an automated glassware washer. Other automated cleaning systems can also be used. With the proposed bonnet assembly, a liquid or solution such as the cleaning solution 18 enters and exits the assembled bonnet assembly 100 through the orifices 15 and through the open bottom face 23 of the bonnet (if open), goes around the parts of the actuator assembly housed inside the bonnet and exits at the orifices 15 and the bottom face 23 of the bonnet (if unobstructed by the diaphragm and/or the valve body) as shown in FIGS. 14B and 15B. There is a free flow of the cleaning solution and unobstructed contact with the parts of the actuator assembly resulting in a thorough cleaning of the bonnet-assembly without the need of disassembling the bonnet assembly. The nature and composition of the cleaning solution and the cleaning conditions such as time, temperature, etc. are at the discretion of the user/manufacturer and are usually dependent upon the practice of the industry, a proprietary information kept by a manufacturer, or one dictated by a regulatory body overseeing the industry. A cleaning solution typically ranges from an acidic pH of 2 to a basic pH of 10. These can also be organic or inorganic in nature or a combination of both. The cleaning solutions may be one or more types of solution which can be applied batch wise in separate steps. The cleaning process, especially one done by submersion can be made more effective by the introduction of sonic waves or by stirring the cleaning solutions during the washing procedure.

Due to the constant exposure of the valve in general and the bonnet assembly, in particular, to the cleaning solutions, the valve or the bonnet assembly should be made up of corrosion resistant materials such as stainless steel and performance engineered polymeric materials. The term performance engineered plastic or polymeric material is used in the art to refer to plastic or polymeric materials formulated to impart a desired performance characteristic/s. The type of performance engineered polymeric material would largely depend on the type of fluid or cleaning solution contacting the valve and the process conditions that the valves are subjected to. The performance engineered polymeric material used herein posses among others the characteristics of non-galling, low coefficient of friction, non-corrosive and for some industries, non-toxic or approved by the regulating agency overseeing the product or fluid being processed with the valve. There is a list of performance engineered polymeric materials that can be used. As in any material, some are better performing than the others. Examples (not a complete list) of performance engineered polymeric material are acrylonitrile butadiene styrene (ABS), fluoropolymers, polyamides (Pas-Nylon), polyarylates (PAryls), polycarbonate (PC), thermoplastic polyesters (PET, PBT), thermoplastic polyimides (PI, PAI, PEI), polyoxymethylene (POM Acetal), polyphenylene oxide (PPO), polyaryletherketones (PEEK, PEK), polysulphones (Psul, PES), polyphenylene sulphide (PPS), liquid crystal polymers (LCPs), fluorinated ethylene propylene (FEP), perfluoroalkoxy (PFA), polyvinylidene fluoride (PVDF), and some amorphous and semi-crystalline thermoplastics. Corrosion causes gradual destruction of a metal or alloy due to an action of a chemical agent or due to chemical processes such as oxidation. In the bonnet assembly, the spindle 6 and 6a, especially those having threaded 24 portions, that allow the movement of the diaphragm 1 and 1a upon the turn of the handle 7 and 7a, should be made not only of a corrosion resistant material but also one that withstands constant frictional rubbing between the surface of the spindle, herein illustrated as threads 24, and the matching/receiving or contacting surface 25 on the actuator to avoid galling which eventually makes the valve non-functional due to seizure or damage especially on the threads if the spindle is threaded. If the bonnet assembly or the valve in general consist of other parts that are threaded, these parts too should be made or fabricated with a corrosion and galling resistant material. Aside from the spindle, the other parts of the actuator assembly receiving or contacting with the surface of the spindle and the bonnet itself can also be fabricated with a performance engineered polymeric material. Present bonnet assemblies usually have the spindle or other parts within the bonnet assembly made of brass or bronze because they are less expensive. Brass and bronze are more susceptible to corrosion. Stainless steel material, on the other hand, although it would improve the life of the spindle and any other threaded part/s of the valve, should be periodically lubricated to minimize the damage due to frictional contact between the spindle and the matching or contacting surfaces of the actuator. The lubricant, often times, are not compatible with the liquid being processed and would present a problem in itself as a contaminant that may be able to seep into the fluid. Also, with the constant contact of the surfaces with the cleaning solutions which may be of extreme pH conditions or of a chemical composition that can react with the lubricant, the lubricant could likely break down into smaller molecular compounds whose effect in the process fluid is mostly unknown and would require a big investment to determine. Stainless steel is susceptible to a galling problem causing an eventual flaking out of contaminants to the environment which would include the fluid contacting the stainless steel. In lieu of this, substituting the spindle or any threaded component of the valve or the bonnet assembly with a performance engineered polymeric material that would withstand corrosion and galling is another aspect being proposed herein to improve the performance and functional life of the valve in general and the bonnet assembly in particular. Providing the actuator part or component directly contacting with the spindle with this performance engineered material especially those that are threaded to match with a threaded spindle, is also recommended. The bonnet housing the actuator assembly can likewise be fabricated with this material.

While the embodiments of the present invention have been described, it should be understood that various changes, adaptations, and modifications may be made therein without departing from the spirit of the invention and the scope of the claims.

We claim:

1. An improved bonnet assembly for a valve, comprising:
a hollow bonnet housing an actuator assembly comprising an actuator connected to a spindle, the hollow bonnet having a plurality of orifices to allow free entry and exit of a liquid within the bonnet, the liquid thoroughly contacting and exiting the bonnet assembly without the need of disassembly;
a handle connected to the spindle of the actuator assembly causing the upwards and downwards motion of the actuator assembly; and,
means for connecting the bonnet assembly to other components of the valve.

2. The bonnet assembly of claim 1 wherein the liquid is a cleaning solution.

3. The bonnet assembly of claim 1 wherein the orifices are of different geometric shape and design.

4. The bonnet assembly of claim 1 wherein the orifice is formed by casting.

5. The bonnet assembly of claim 1 wherein the orifice is bored at a lateral surface of the hollow bonnet;

6. The bonnet assembly of claim 1 wherein the plurality of orifices are dependent upon the surface area of the bonnet and the structural strength of the bonnet required to house the actuator assembly.

7. The bonnet assembly of claim 1 wherein the valve having the bonnet assembly is made of a corrosion and galling resistant material.

8. The bonnet assembly of claim 7 wherein the corrosion and galling resistant material is a performance engineered polymeric material.

9. The bonnet assembly of claim 1 wherein the bonnet assembly is made of a corrosion and galling resistant material.

10. The bonnet assembly of claim 9 wherein the corrosion and galling resistant material is a performance engineered polymeric material.

11. The bonnet assembly of claim 1 wherein the spindle is made of a corrosion and galling resistant material.

12. The bonnet assembly of claim 11 wherein the corrosion and galling resistant material is a performance engineered polymeric material.

13. The bonnet assembly of claim 1 further comprising threaded parts aside from the spindle.

14. The bonnet assembly of claim 13 wherein the threaded parts aside from the spindle is made of a corrosion and galling resistant performance engineered polymeric material.

15. The bonnet assembly of claim 1 wherein the valve having the bonnet assembly is a weir type valve or a radial style valve.

16. An improved bonnet assembly for a valve, comprising:
a hollow bonnet housing an actuator assembly comprising an actuator connected to a spindle made of a corrosion and galling resistant performance engineered polymeric material, the spindle having threads engaging a matching surface on the actuator;
a handle connected to the spindle of the actuator assembly causing the threads of the spindle to engage upwards and downwards along the matching surface of the actuator as the handle moves the actuator assembly up and down; and,
means for connecting the bonnet assembly to other components of the valve.

17. The bonnet assembly of claim 16 wherein the corrosion and galling resistant performance engineered polymeric material is selected from the group consisting of acrylonitrile butadiene styrene (ABS), fluoropolymers, polyamides (Pas-Nylon), polyarylates (PAryls), polycarbonate (PC), thermoplastic polyesters (PET, PBT), thermoplastic polyimides (PI, PAI, PEI), polyoxymethylene (POM Acetal), polyphenylene oxide (PPO), polyaryletherketones (PEEK, PEK), polysulphones (Psul, PES), polyphenylene sulphide (PPS), liquid crystal polymers (LCPs), fluorinated ethylene propylene (FEP), perfluoroalkoxy (PFA), and polyvinylidene fluoride (PVDF).

18. An improved bonnet assembly for a valve, comprising:
a hollow bonnet housing an actuator assembly comprising an actuator connected to a spindle made of a corrosion and galling resistant performance engineered polymeric material, the spindle having threads engaging a matching surface on the actuator, the hollow bonnet having a plurality of orifices to allow free entry and exit of a liquid within the bonnet, the liquid thoroughly contacting and exiting the bonnet assembly without the need of disassembly;
a handle connected to the spindle of the actuator assembly causing the threads of the spindle to engage upwards and downwards along the matching surface of the actuator as the handle moves the actuator assembly up and down; and,
means for connecting the bonnet assembly to other components of the valve.

19. The bonnet assembly of claim 18 wherein the liquid is a cleaning solution.

20. The bonnet assembly of claim 19 wherein the valve having the bonnet assembly is a weir type valve or a radial style valve.
